(19) United States
(12) Patent Application Publication
(10) Pub. No.: US 2006/0158707 A1
(43) Pub. Date: Jul. 20, 2006

(54) Mount for an optical element, method for fitting an optical element on a mount and method for manipulating an optical device

(76) Inventors: Tilmann Schwertner, Aalen (DE); Hans-Joachim Weippert, Aalen (DE); Uwe Hamm, Langenau (DE)

Correspondence Address: Holland & Knight LLP;One East Broward Boulevard, Suite 1300, P.O. Box 14070, Ft. Lauderdale, FL, 33302-4070, US

(21) Appl. No.: 11/319,143

(22) Filed: Dec. 27, 2005

Related U.S. Application Data
(60) Provisional application No. 60/639,518, filed on Dec. 28, 2004.
(60) Provisional application No. 60/698,300, filed on Jul. 12, 2005.

(51) Int. Cl. G02B 5/32

(52) U.S. Cl. 359/15

(57) ABSTRACT

A mount for an optical element has a fitting area for fitting the optical element. Located in the fitting area is an additional material whose state can be changed by means of a state changing device in such a way that following change of state of the additional material the optical element is held in the mount in a form-fitting and releasable fashion by the additional material. Furthermore, provided is a method for manipulating an optical device which comprises providing an optical element attached to an optical device by an adhesive, said adhesive comprising particles susceptible to a magnetic field. In a second step a magnetic field is applied to the adhesive. Also provided is an optical device to be used in conjunction with this method.

This application claims the benefit under 35 U.S.C. 119(e)(1) of U.S. Provisional Application No. 60/639,518 filed on Dec. 28, 2004 and of U.S. Provisional Application No. 60/698,300 filed on Jul. 12, 2005.

### BACKGROUND OF THE INVENTION

1. Field of the Invention

This application relates to a mount for an optical element having a fitting area for fitting the optical element. The invention further relates to a microlithography objective having a number of optical elements, and to method for fitting an optical element on a mount having a fitting area. Furthermore, the application relates to a method for manipulating optical devices and optical devices useful in the practice of this method. This application relates in particular to a method for manipulating optical devices and corresponding devices used for high performance optical lithography.

2. Related Prior Art

Optical lithography is a technique used to produce minute electronic circuits on the surface of a silicon wafer in order to produce so-called integrated circuits (ICs) or computer chips. In this method, a beam of radiation is used to transfer a pattern from a reticle onto a silicon wafer coated with a radiation sensitive substance (resist). After the pattern has been projected onto the resist coated wafer, the resist is either removed in areas where it has been in contact with the radiation (positive resist) or the resist is hardened in areas where it has been in contact with the radiation (negative resist). After this exposure to radiation the silicon wafer can be further processed by various techniques such as doping or etching.

In recent years there has been a demand for ICs with a growing degree of integration, generating the need for ICs with finer and finer structures. This in turn has lead to a demand for lithographic projection systems which are able to project finer and more complex patterns onto the substrate, demanding a higher and higher degree of accuracy from the projection systems.

One of the problems encountered in these systems is that the lenses used are not perfect lenses and therefore lead to optical aberrations within the beam of radiation. Such aberrations reduce the accuracy of these systems. In order to counter these aberrations special means must be provided for the optical systems.

Such optical aberrations can e.g. take the form of a loss of focus. Therefore, means to reestablish the focus must be provided.

Another type of aberration is constituted by the so-called wavefront aberrations. Ideally, a wavefront is perfectly planar. Passing through lenses can “warp” this planar wavefront causing peaks and valleys. This also will cause a loss of accuracy. These wavefront aberrations are corrected by artificially inducing wavefront aberrations which show a phase directly opposed to the aberrations present in the wavefront. This way the wavefront aberrations will cancel each other out, leading to a wavefront which is almost perfectly planar. The ore precisely the artificial wavefront aberrations are created the closer one can get to a perfectly planar wavefront. Such artificially created wavefront aberrations are for example generated by inducing strain or tension within optical elements arranged in the beam of radiation.

As long as the occurring aberrations are static, i.e. do not change over time, static systems can be used to correct them. Such systems are not necessarily simple to calibrate, but once they are calibrated they can be used without further interventions for long periods of time.

Some of the aberrations occurring in optical devices such as lithographic projection systems though are not static but dynamic, i.e. they change over time. These dynamic aberrations can result, for example, from the fact that during use the optical device will heat up, leading to parts of it expanding, possibly with different expansion coefficients, leading to tensions within the optical system. Such tensions, especially when transferred onto the optical elements, can lead to optical aberrations.

Although one might think that it is possible to avoid such aberrations by trying to run such an optical device at the same temperature throughout the production cycle, it has been shown that after cooling down such a device and warming it up again to restart the production cycle, for example, after changing the reticle, the optical aberrations do not necessarily constantly reappear in the same way.

Aberrations can also be caused by the fact that the materials of an optical device age at different speeds. One group of materials that is especially susceptible to such an aging process are the adhesives and the sealants used in the production of those optical devices. Such sealants and adhesives will, even after thoroughly hardening them, for example, show a certain plasticity which can lead under the influence of gravity and the weight of an optical element joined to the sealant to minute deformations. Again, this can lead to tensions within the optical elements of the optical device which will lead to optical aberrations.

It needs to be added that further on in the application only the expression adhesive will be used, but it is understood that this comprises all sorts of plastic and rubber materials used as adhesives, sealants, fillers or in any other function within an optical device.

It was therefore necessary to develop corrective elements within an optical device which can be dynamically adapted to the changing aberrations of the optical device in order to guarantee the highest possible accuracy within the optical system and the lowest margin of variance.

One type of system used to correct those dynamic aberrations are mechanical systems which rely purely on mechanical means to change the optical properties of one or several optical elements within the optical device in order to correct optical aberrations. Such means include for example screw-based systems or mechanical actuators in order to shift or tilt the optical axis of an optical element in relation to the optical device or to induce tension or deformations in the optical element in order to correct wavefront aberrations.

These systems have the problem that their accuracy is limited by the degree of accuracy with which the mechanical parts can be manufactured. A further problem arises from the fact that the more precisely those mechanical devices are manufactured the more likely they are to suffer from wear and thereby from a loss of accuracy so that in some ways such systems can contribute to the problem rather than being a solution.

A further problem related to actuator based systems is that they tend to be large and bulky. Such systems also add considerably to the complexity and therefore the cost of an optical device. A more complex device is also more susceptible to failures.

Another device for compensating for optical aberration comprises so-called katadioptric projection systems which involve the use of mirrors in order to manipulate the beam of radiation used for projecting the pattern from the reticle onto the substrate. It has been known that the mirrors in such a system can be designed to include a piezoelectrical layer which can be used to deform the mirror. Such mirrors can then be used to precisely manipulate the beam of radiation in order to compensate for optical aberrations.

The problem with these systems is that in form of the mirrors they need additional optical elements which do not necessarily contribute to the performance of the optical device itself. Therefore, devices using such systems are more complicated and more susceptible to interference than normal lens only systems.

Various types of bearing or mount for optical elements are known from the prior art.

An elastic bedding that has a multiplicity of flexible support points and can be used, for example, in microlithography objectives is described in DE 198 59 634 A1. This elastic bedding has the disadvantage, however, that deviations in the shape of mechanical or optical components are directly converted into a deformation of the optics. The principal fraction of the deformations is determined by the mechanics as a rule.

EP 1 081 521 A2, EP 1 179 746 A2 or EP 1 279 984 A1 describe isostatic mounts for objectives in the case of which the optical element is supported by three support points. The isostatic mounting technology has the disadvantage in principle that it is necessary to minimize the surface area of the three support points in order to reduce the influence of disturbing forces and disturbing moments which are mostly produced by manufacturing tolerances. The reduction in supporting surface area leads, however, to local stress peaks in the optics and the mechanics, something which can lead to stress relaxation and thereby to an unsatisfactory long-term stability of the mount. The above named examples of isostatic mounting technology render it clear that decoupling the disturbing forces and disturbing moments can be done only by means of complicated decoupling mechanisms that, however, have a multiplicity of contact surfaces and therefore in turn induce disadvantageous setting effects.

The mount and the optics need to be sealed off when the aim is to flush air spaces or to correct aberrations by means of different gas pressures. However, in the case of isostatic bearings the problem arises that the three support points result in a trefoil nature of the optics, as is the case, for example, in the solution in accordance with EP 1 279 984 A1. Again, the sealing concept used there is completely unsatisfactory for use in microlithography.

EP 1 318 424 A2 discloses the bearing of an optical element by means of a fluid in the field of microlithography. However, this requires a considerable outlay on control together with an appropriate sensor system, and there is, furthermore, the risk of the flowing fluid coupling vibrations into the optics owing to pressure fluctuations, and in this way inducing a contrast loss in the image.

The bearing of an optical element with the aid of an electromagnetic field is described in DE 100 19 562 A1. This admittedly relates in principle to a mixed form of an elastic bedding and the bearing via a constant force, specifically the force applied by the magnetic field, but owing to the flat mechanical contact there is fundamentally an elastic bedding, for which reason the mechanical shape deviations determine the deformation of the optics, as described above with reference to DE 198 59 634 A1.

In the case of the solution in accordance with U.S. Pat. No. 5,973,863, washers which are also denoted in general as spacers, are inserted in the case of microlithography objectives for the purpose of centring the optics with respect to a reference axis, and for changing the distances between individual optics. The use of such spacers is, however, problematical, since the accuracy of the spacers is determined in principle by manufacturing tolerances, and time-dependent variations in the position of the mounts can result if stress peaks come about at the contact points between the spacers and the mount. Furthermore, the partial contact between the multiplicity of spacers and the mount leads to a sagging of the mount because of the weight force, something which in turn entails a waviness of the optics that depends on the number of the spacers.

JP 2002 156571 A discloses a bearing method and a corresponding apparatus in the case of which an optical element is held in a mount by means of tubing filled with air.

In a similar way, JP 2002 318334 A also describes a means of holding a mirror with the aid of an elastic ring that is filled with a settling fluid, for example a liquid such as water or alcohol, or a gas such as argon, helium or nitrogen.

However, the strong dependence on the gas or liquid filling, and the fluctuations associated therewith, are disadvantageous in these solutions.

Bonded connections between an optical element and a mount by means of the use of soldering methods are described, for example, in EP 0 901 992 B1 or DE 197 55 356 A1. However, it is disadvantageous here that the optical element cannot be demounted from the mount without being destroyed, and therefore cannot be easily exchanged. This holds mostly also for the bonding of optical elements to their mounts. A further disadvantage of bonded connections is the oxidation frequently occurring in the boundary layers, which can have a negative influence on the properties of the optical element.

DD 204 320 describes an arrangement of optical components in mechanical guides, in the case of which arrangement the mechanical contact surfaces of the optical components are provided with a carrier material and produce an axial self-closure between the optical component and a mechanical guide.

All the above named solutions are not capable of preventing a deformation of the optical element induced by the bearing, or they require complicated processing steps to release the connection and thus for exchanging the optical element.

It is therefore an object of the present invention to provide a mount for an optical element and a method for fitting an optical element on a mount in the case of which for the purpose of as simple a design as possible, there is a slight deformation of the optical element and, moreover, the connection can be released with a low outlay.

A further object of the invention is to describe a method for manipulating an optical device as well as an optical device that can be used in situations in which static as well as dynamic optical aberrations need to be corrected with high precision and yet add little to the complexity and cost of the system.

### SUMMARY OF THE INVENTION

According to one aspect of the invention, this object is achieved by a mount for an optical element having a fitting area for fitting the optical element, wherein located in the fitting area is an additional material whose state can be changed by means of a state changing device in such a way that following change of state of the additional material the optical element is held in the mount in a form-fitting and releasable fashion by the additional material.

By changing the state of the additional material with the aid of the state changing device, the mount according to the invention enables the optical element to be held in a form-fitting fashion in the mount, as a result of which said element is held in planar fashion around its entire circumference, and is therefore exposed to extremely slight deformations. The form-fitting holding of the optical element in the mount offers the further advantage that manufacturing tolerances and shape deviations, resulting therefrom, of the optical element and/or the mount are negligible, since they have no influence on the geometry and the alignment of the optical element. Moreover, the form-fitting connection results in a constant surface pressure of the mount with reference to the optical element, and thus in a constant force distribution.

A further advantage of the solution according to the invention consists in that the optical element is held releasably in the mount, as a result of which there is no need to apply a mechanical force to remove the optical element from the mount. Consequently, during removal and the later reinsertion no deformation of the optical element results, and so said element can be exchanged without a problem, for example in order to carry out the processing on the same. Moreover, the additional material also ensures that the optical element is sealed with reference to the mount.

In a particularly advantageous embodiment of the invention, it can be provided that the additional material is a magnetorheological liquid. If, moreover, it is provided in this connection that the state changing device has at least one magnet whose magnetic force can be varied in such a way that the viscosity of the magnetorheological liquid changes, this constitutes an embodiment of the form-fitting fitting of the optical element on the mount that is very simple in design terms and very advantageous with reference to the reduction in the deformation of the optical element, since the change in the viscosity or the stiffness of the magnetorheological liquid keeps the optical element in the mount in a fashion that is approximately floating and therefore approximately free of force. Moreover, the magnetorheological liquid produces a hydraulic bearing and a damping of the optical element in the event of possible vibrations.

However, the additional material can also be an electrorheological liquid.

If, furthermore, the magnet has a number of electric coils by means of which the magnetic force can be varied, the optical element can be displaced or tilted inside the mount to a certain extent by such a variation in the magnetic force, for example in order to adapt the optical element to specific imaging conditions.

As an alternative to the use of the magnetorheological liquid in conjunction with magnetic force, it is also possible for the additional material to be a metal, it being particularly advantageous in this context when the state changing device has at least one heat inputting device, where the metal can be brought from a solid into a liquid state by heat input by means of the heat inputting device, and where the metal can be brought from a liquid into a solid state by reducing the heat input by means of the heat inputting device.

Such a solution enables the optical element to be fitted on the mount virtually without force, here, as well, a solution that is easy to construct and therefore can be mastered in practice without a problem being provided.

Claim 13 specifies a microlithography objective having a number of optical elements of which at least one is held by means of a mount according to the invention.

A method for achieving the object follows from the features of claim 14.

The method according to the invention can be carried out with particular ease, specifically in such a way that the optical element is brought into the fitting area of the mount and the mechanical properties of the additional material are changed in order to enable the optical element to be held on the mount in a form-fitting fashion.

In a further aspect of the invention the above mentioned object is achieved by a method for manipulating an optical device which comprises providing an optical element attached to an optical device via an adhesive comprising particles susceptible to a magnetic or electric field, the magnetic permeability or dielectric constant of said adhesive being at least 50% higher with the particles susceptible to a magnetic or electric field than without the particles, and applying a magnetic or electric field to the adhesive for manipulating the optical element.

In another aspect of the invention the object is achieved by an optical device comprising at least one optical element, the optical element being attached to an optical device via an adhesive comprising particles susceptible to a magnetic or electric field.

According to the invention, one or more optical elements within an optical device are attached to the optical device using not a standard adhesive but an adhesive which comprises particles susceptible to a magnetic or electric field. If a magnetic or electric field is applied to such an adhesive, whether it is before or after the adhesive has hardened, the adhesive and therefore the optical element will be manipulated by the magnetic or electric field.

The change in permeability of the adhesive or the additional material makes it possible to change the outer shape of the basic substance by applying a magnetic or electric field. This effect can be made use of for holding the optical element in the mount or for manipulating the optical element relative to the mount.

The manipulations can thereby include a change in position of the optical element, such as a tilting, shifting or rotating of the optical element or the application of pressure or strain to the optical element, e.g. in order to induce tensions within the optical element.

The influence of the magnetic or electric field on the change in position of the optical element is greatly higher, e.g. 10 or even 100 to 1000 times higher, than the deformation of the optical element caused by the magnetic or electric field.

The application of pressure or strain to an optical element can be used to induce wavefront aberrations in a beam of radiation passing through the optical element. If this is done in a directed manner, it can be used to induce wavefront aberrations having phases inverse to those of the aberrations present in the wavefront of a passing beam of radiation in order to cancel out these aberrations as previously described.

The change in position of the optical element, for example by tilting, can e.g. be used to compensate for aberrations by which a beam of radiation is displaced from the intended optical axis.

The adhesives used in the invention comprise two main parts. First of all, the adhesive itself and second, the particles susceptible to a magnetic or electric field. The adhesive can be any adhesive used in the industry, such as adhesives based on polyurethanes, epoxides, acrylates, polythiourethanes, polysulfides, rubbers, silicones, and silicone rubbers or mixtures thereof.

The particles susceptible to a magnetic or electric field are used as a filler and can comprise any particles that can be influenced by a magnetic or electric field such as magnetic of magnetizable particles. Examples for such particles comprise:

Ferromagnetic particles such as:
metals such as Fe, Co, Ni, and alloys such as Fe—Si, Fe—Al, Fe—Ni, Fe—Co;
cubic ferrites of the general formula MeO—Fe₂O₃, wherein Me can be Fe, Ni, Co, Mn, Mg, Cu, Ti, Cd or Zn;
hexagonal ferrites and barium ferrites such as BaO.2FeO.8Fe₂O₃;
microwave ferrites of the general formula A₃B₂Si₃O₁₂, such as Mn₃Al₂Si₃O₁₂ or SE₃Fe₅O₁₂ wherein SE can be a rare earth metal or Y.

Metallic permanent magnetic particles such as:
alloys of the AlNiCo group with Fe, Co, Ni, Al, Cu and Ti;
Fe—Co—V, Co—Pt, Fe—Co—W and Fe—Co alloys.

Ceramic ferrimagnetic particles such as:
MeFe₁₂O₁₉ such as PbFe_{7.5}Mn_{3.5}Al_{0.5}Ti_{0.5}O₁₉
barium ferrite BaO.6Fe₂O₃
strontium ferrite
lead ferrite.

Intermetallic particles of the SECo₅ group, whereby SE can be Sm, Y, La or Pr, such as SmCo₅.

Magneto-strictive particles such as ferromagnetic particles, such as Fe, Co and Ni as well as their alloys.

Depending on the type of particles susceptible to a magnetic or electric field used and on the effect desired the magnetic or electric field can be applied temporarily, for example, in order to induce only temporary aberrations in the optical element or if the particles can be permanently magnetized. If a continuous aberration is desired the magnetic field can be applied continuously.

The above described method is preferably performed iteratively using a feedback control, preferably an electronic one, whereby a sensor reads an optical property of the optical device, compares this to a given value and manipulates the magnetic field in order to adjust the optical property. Although it is theoretically possible to perform this adjustment method manually, it is preferably performed using an integrated electronic system specifically designed to perform this task due to the minute adjustments that need to be made.

The magnetic field can be applied with permanent or non-permanent magnets, such as electromagnets.

If permanent magnets are used they can either be installed in a fixed position with regards to the optical element and the adhesive comprising particles susceptible to a magnetic field, or they can be attached in a movable fashion. A movable fashion is hereby preferable since this way the system can be used to compensate for dynamic aberrations by moving the permanent magnets in relation to the optical element and the adhesive comprising particles susceptible to a magnetic field.

In one embodiment in which a permanent magnet is used the optical element fixed with the adhesive comprising particles susceptible to a magnetic field is completely surrounded by a ring-shaped permanent magnet whereby one or more piezoelectric elements are arranged at said permanent magnet. Such (a) piezoelectric element(s) comprise(s) a number of electrodes which can be individually activated, e.g. by a control unit, and which are used to create a piezoelectric effect which influences the magnet and thereby the magnetic field generated by it.

Another possibility is the provision of one or more electromagnets which can be individually activated, for example, by a control unit in order to generate the magnetic field applied to the adhesive comprising particles susceptible to a magnetic field.

This way the invention provides a method for manipulating an optical device and a corresponding device which can be used to dynamically correct optical aberrations with a minimum of moving parts but a high degree of accuracy.

In the following, a number of adhesives comprising particles susceptible to a magnetic field that can be used in the invention will be described.

1. Polyurethane-based systems:
polyol component, 20 parts by weight,
iron filings, average size about 10 μm 80 parts by weight
polyisocyanate, e.g. diphenylmethane-4,4′-diisocyanate,
5 parts by weight
hardens at room temperature.

2. Epoxy resin-based systems:
bisphenol-A diglycidyl ether, 100 parts by weight
iron filings, average size about 10 μm, 500 parts by weight
isophorondiamine, 22 parts by weight
hardens at room temperature or at 40 to 80° C.;
hydrogenated bisphenol-A diglycidyl ether, 100 parts by weight
iron filings, average size about 10 μm, 500 parts by weight
methylhexahydrophthalic acid anhydride, 70 parts by weight
accelerator (tertiary amine-based), 3 parts by weight
preharden at 80° C. (8 hours) and fully hardens at 130° C. (15 hours).

3. Epoxy—polythiol-based system:
hydrogenated bisphenol-A diglycidyl ether, 100 parts by weight
trimethylolpropane-tris(mercaptopropionate), 25 parts by weight
iron filings, average size about 10 μm, 500 parts by weight
isophorondiamine, 12 parts by weight
hardens at room temperature.

4. Polysulfide-based system:
thiokoll, 100 parts by weight
carbon black, 10 parts by weight
iron filings, average size about 10 μm, 400 parts by weight
hardener (50 parts by weight lead oxide and 50 parts by weight phthalic acid polyester), 10 parts by weight hardens at room temperature.

All these examples describe adhesives that can be used in the invention but they are not meant to limit the scope of the invention to those combinations. The described adhesives can be used in the same manner and with the same performance as conventional adhesives used in the optical industry.

### BRIEF DESCRIPTION OF THE DRAWINGS

Embodiments of the invention will now be described by way-of example only with reference to the accompanying drawings in which

FIG. 1 shows a first embodiment of a mount according to the invention for an optical element;

FIG. 2 shows a second embodiment of a mount according to the invention for an optical element;

FIG. 3 shows a schematic representation of a lithographic projection system for use in a method of the invention;

FIG. 4 shows a partly cut away representation of a first device of the invention;

FIG. 5 shows a schematic representation of a second device of the invention;

FIG. 6 shows in section a third device of the invention;

FIG. 7 shows in section a forth device of the invention;

FIG. 8 shows in section a fifth device of the invention; and

FIG. 9 shows a second view in section of the device according to FIG. 8.

### DETAILED DESCRIPTION OF EMBODIMENTS

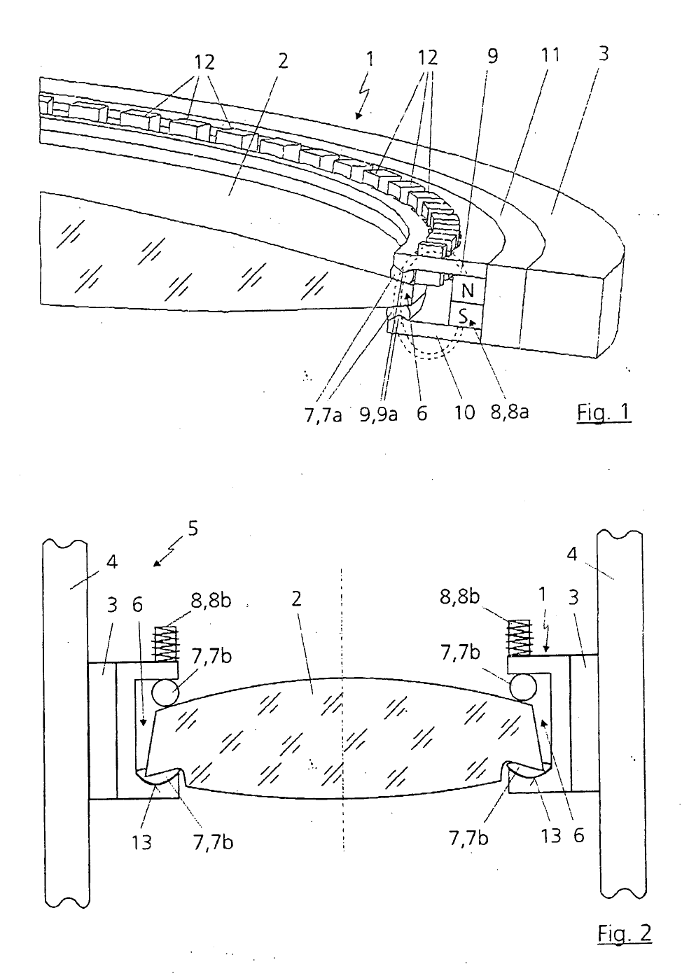

FIG. 1 shows a mount 1 on which an optical element 2 can be fitted, or in which the same can be held. The mount 1 has an outer ring 3 that, as indicated in the embodiment in accordance with FIG. 2, can be fitted to a housing 4 of a microlithography objective 5 indicated only schematically. In the present case, the optical element 2 is a lens, but it is also possible to provide other types of optical elements 2 such as, for example, mirrors. Also possible, moreover, is the use of the mount 1 in an optical apparatus differing from the microlithography objective 5.

In the present case, the mount 1 has a fitting area 6 that circulates in an annular fashion and serves for fitting the optical element 2 on the mount 1. In the illustrated situation, in which the optical element 2 is already fitted on the mount 1, there is located in the fitting area 6 an additional material 7 whose state can, as explained below, be changed by means of a state changing device 8 in such a way that after the change of state of the additional material 7 the optical element 2 is held in a form-fitting and releasable fashion in the mount 1 by the additional material 7. The optical element 2 is rendered gastight when held in the mount 1.

In the present case, the additional material 7 is a magnetorheological liquid 7a, and the state changing device 8 is designed as a magnet 8a. Fitted on the magnet 8a, which has in a way known per se a north pole, denoted by “N”, and a south pole, denoted by “S”, are mutually opposite pole shoes 9 and 10 that are likewise circulating and are connected to the additional material 7. In the illustrated embodiment, there is an upper pole shoe 9 and a lower pole shoe 10. In this way, the magnetic field lines emanating from the magnet 8a and illustrated in the present case by means of dashed lines run through the two pole shoes 9 and 10 to form a closed circuit that runs both through the additional material 7 and through the optical element 2. The optical element 2 does not disturb the magnetic field lines. The additional material 7 could also be an electrorheological liquid if the magnetic field is replaced by an electric field.

The pole shoes 9 and 10 ensure, moreover, that the optical element 2 is sealed with respect to the mount 1, and so there is no need to provide additional sealing therefore. The pole shoes 9 and 10 are provided with respective tips 9a and 9b that extend into the additional material 7 and ensure appropriate alignment of the magnetic field through the additional material 7 and the optical element 2. In order to prevent a short circuit of the magnetic field by the outer ring 3, an insulator 11 made from a material, or with a shaping of a high magnetic resistance or a low permeability constant of the material such as, for example, aluminum or plastic, is arranged between the outer ring 3 and the magnet 8a.

The magnetorheological liquid 7a consists, for example, of an oil and ferromagnetic particles contained in the oil, such that a dispersion is present in principle. The field lines emanating from the magnet 8a after actuation thereof align the ferromagnetic particles in the liquid, the oil, such that the viscosity of the magnetorheological liquid 7a is raised, and the stiffness thereof increases. A substantial advantage of the additional material is that the additional material 7 adapts to the shape of the optical element 2 and holds the latter in the mount 1 in a form-fitting fashion, as a result of which the optical element 2 arranged between the pole shoes 9 and 10 is held by the additional material 7 in an approximately floating, force-free position inside the mount 2, and is held in planar fashion over its entire circumference.

The stiffness or viscosity of the magnetorheological liquid 7a can be set by varying the fraction of the particles in the magnetorheological liquid 7a, a higher viscosity or a higher stiffness being possible through a higher number of particles.

It is thereby possible to adapt the stiffness via the concentration of the ferromagnetic particles. It is possible in this way, for example, for the magnetorheological liquid 7a situated on the topside of the optical element 2 between the upper pole shoe 9 and the optical element 2 to be set softer than the magnetorheological liquid 7a on the underside of the optical element, that is to say between the optical element 2 and the lower pole shoe 10. The magnetic permeability or the electric permittivity (dielectric constant) of the additional material 7 is at least 50% higher with the particles susceptible to the magnetic or electric field than without the particles. Most preferably, the magnetic permeability of the electric permittivity of the additional material 7 is 2, 10 or even 100 times higher with the particles than without the particles.

Provided over the entire circumference of the mount 1 in order to vary the magnetic field strength are a number of electric coils 12 that are capable of influencing the magnetic field, and thus of changing the viscosity of the magnetorheological liquid 7a within specific limits such that the viscosity of the magnetorheological liquid 7a also changes as a consequence. The changes in the magnetic field are preferably performed locally by means of the coils 12, which can be controlled and/or regulated, in order to change the viscosity 7 of the additional material 7, for example the liquid 7a, in a local fashion, that is to say along a circumferential range. It is thereby possible, for example, to change the tilt of the optical element 2, or to displace the same by a certain amount in the longitudinal direction (in the direction of the optical axis or, given a suitable configuration of the tips 9a, 9b, in a direction perpendicular to the optical axis). Furthermore, by varying the viscosity of the magnetorheological liquid 7a the natural frequency of the optical element 2 can also be varied, something which can happen both statically owing to an appropriate design of the magnetic circuit, and also dynamically by appropriately driving the electric coils 12. These possibilities of control or regulation are possible in each case by means of electrical signals.

In order to fit the optical element 2 on the mount 1, the optical element 2 is preferably firstly brought into the fitting area 6 between the pole shoes 9 and 10. Subsequently, the additional material 7 is introduced into the fitting area 6, into the annular free space between the optical element 2 and the pole shoes 9 and 10, the additional material 7 still having a relatively low viscosity, that is to say being in a liquid state, and therefore being able to be distributed along the annular gaps between the optical element 2 and the two pole shoes 9 and 10. The above-described change in the viscosity of the additional material 7 then enables the optical element 2 to be held in a form-fitting fashion in the mount 1.

By switching off the magnet 8a, and thus the magnetic field, the viscosity of the magnetorheological liquid 7a is reduced again, as a result of which the form fit between the optical element 2 and the mount 1 is released without the expenditure of mechanical force. The optical element 2 can be removed very easily from the mount 1 in this way at any time.

An alternative embodiment of the mount 1 for holding the optical element 2 is illustrated in FIG. 2. Here, the additional material 7 is preferably designed as a low-melting metal 7b, and the state changing device 8 is designed as a heat inputting device 8b, that is to say as the heating loop or the like, for example. The heat inputting device 8b is capable of changing the aggregate state of the metal 7b, and in this case the metal 7b can be brought from a solid into a liquid state by heat input by means of the heat inputting device 8b, and the metal 7b can be brought from a liquid into a solid state by reducing the heat input by means of the heat inputting device 8b.

The significance of this for the method for fitting the optical element 2 on the mount 1 is that the optical element 2 is brought in the liquid state of the metal 7b into the fitting area 6, and that the heat input is subsequently set by the heat inputting device 8b, as a result of which the metal 7b solidifies and holds the optical element 2 in a form-fitting fashion in the mount 1. No bonded fit comes about here between the additional material 7 and the optical element 2. Provided in the present case in the fitting area 6 is a trough-shaped receptacle 13 in which the metal 7b is located such that the metal 7b also remains in the fitting area 6 whenever it is in its liquid aggregate state. If the optical element 2 is provided with a suitable undercut, such that there is self-closure between the optical element 2 and the additional material 7 upwardly as well, it can suffice to provide the additional material 7 only underneath the optical element 2. The metal 7b can be a low-melting metal, for example a bismuth alloy that has a melting point of 50° C, for example. Apart from the possibilities represented for varying the mechanical properties of the additional material 7 by means of the magnet 8a and the heat inputting device 8b, it would also be conceivable to change the mechanical properties of the additional material 7 by means of ultraviolet radiation.

Furthermore, it is also possible to use as additional material 7 a jelly-type or rubber-type material that is permeated with paramagnetic, preferably ferromagnetic particles such that the shape and stiffness or the elasticity of the additional material 7 can be varied by means of the magnetic field.

Furthermore, the additional material 7 can generally also be arranged on the circumference of the optical element 2 such that it is possible by applying a magnetic field to displace the optical element 2 not only along its longitudinal direction (optical axis) or to tilt it about an axis perpendicular to its longitudinal direction, but also deliberately to displace it in a direction perpendicular to the optical axis (longitudinal direction). Appropriate thrust bearings against which the additional material 7 bears are formed in this case at the outer ring 3.

Embodiments resulting from a combination or exchange of features of the embodiments presented above and in the following are likewise advantageous designs of the invention. Thus, for example, the embodiments illustrated in FIGS. 1 and 2 can be combined with a jelly-type or rubber-type additional material 7, fitted on the circumference of the optical element 2, having paramagnetic or ferromagnetic particles, in order additionally to permit the possibility of adjusting the optical element 2 in the radial direction or, more generally, in a direction perpendicular to the optical axis.

Furthermore, by combining the heat inputting device 8b of the exemplary embodiment from FIG. 2 with the design according to FIG. 1, it is possible, for example, also to regulate or control the temperature of the additional material 7 for example, the liquid provided with ferromagnetic particles, for example, in order in addition to influence the stiffness or viscosity of the liquid 7a, in general the additional material 7, for example. In general, the heat inputting device 8b can input heat into or extract heat from the additional material 7 such that targeted heating or cooling is possible, for example.

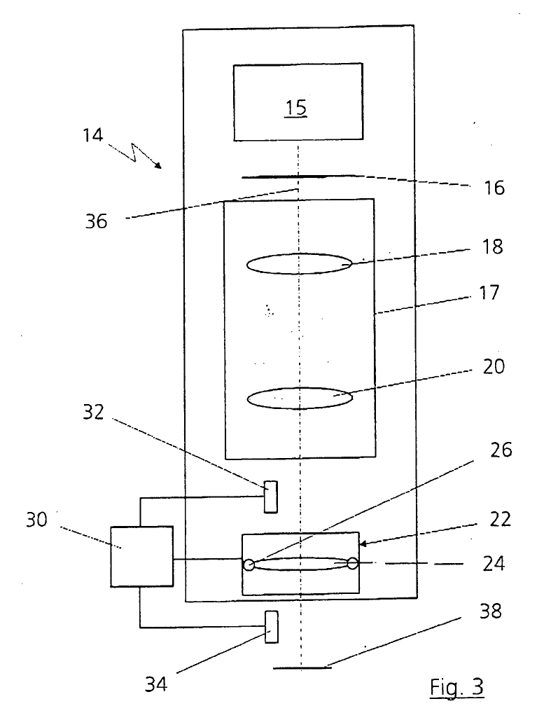

In FIG. 3 a lithographic projection system in its entirety is assigned the reference numeral 14.

The lithographic projection system 14 comprises a radiation source 15, a reticle 16 and a lens system 17. The lens system 17 comprises a number of individual optical elements of which for sake of simplicity only two lenses 18 and 20 are shown in this drawing.

The projection device 14 further comprises a correction device 22. This correction device 22 is integrated into the lithographic projection system and could also be part of the lens system 17. It is also possible to design the correction system 22 as an independent unit that can be retrofitted onto existing lithographic projection systems.

The correction system 22 comprises an optical element which in this case is a lens 24 which has been fixed to the correction system 22 via an adhesive 26. The optical correction system 22 further comprises a device 28 for applying a magnetic field to the adhesive 26. In this case the device 28 comprises thirty-two independent electromagnets.

The device 28 for applying a magnetic field to the adhesive 26 is connected to a control unit 30. This control unit 30 is connected to two sensors 32 and 34.

When the projection device 14 is used to irradiate substrates, the radiation source 15 generates a beam of radiation 36 which passes through the reticle 16 into the lens system 17. The beam of radiation 36 comprises light of a deep UV-wavelength. Within the lens system 17, the beam of radiation 36-is focused and otherwise manipulated depending on the desired effect. Since the lenses 18 and 20, although they are produced to a very high standard, are not perfect, aberrations are caused within the beam of radiation 36. These aberrations can be measured with the sensor 32, which in this case is an interferometer, after the beam of radiation 36 leaves the lens system 17.

The aberrations measured by the sensor 32 are reported to the control unit 30. The control unit 30 decides on the necessary aberrations that must be induced in the beam of radiation 36 in order to cancel out the present aberrations and instructs the device 28 for applying a magnetic field to apply a specific magnetic field to the adhesive 26 in order to manipulate the lens 24.

Such manipulations can include the tilting or shifting of the lens 24 in order to realign the beam of radiation 36 with a desired optical axis, or it can include inducing tensions within the lens 24 in order to generate optical aberrations to cancel out aberrations present in the beam of radiation 36. Once the beam of radiation 36 leaves the correction device 22, it passes the sensor 34 which again is an interferometer which is connected to control unit 30. The information obtained by the control unit 30 from sensor 34 can be used to confirm whether the manipulations by the correction device 22 have been sufficient in order to correct the optical aberrations present in the beam of radiation 36 to a satisfactory manner. If this is the case the central unit 30 sends no more signal to the correction device 22.

This corrective process can be performed iteratively. This means the aberrations in the beam of radiation 36 are measured before any corrective action is taken. In a next step corrective actions are taken and their effect on the beam of radiation 36 is measured. If the beam of radiation 36 shows the desired properties no more corrective actions are taken. If the beam of radiation 36 does not show the desired properties, new corrective actions are taken. In this step the effect of the previous corrective action on the beam of radiation 36 can be determined and this information can be used to select the new corrective actions to be taken. All these steps are best performed using a feedback system and a computer integrated in such a system.

After passing the sensor 34, the beam of radiation 36 hits the substrate 38 which, in this case, is a resist covered wafer and projects a pattern from the reticle 16 onto the wafer 38. =p Although this system comprises two sensors 32 and 34, it is also imaginable to produce a system which only comprises a single sensor which is situated after the correction device 22 and which simply measures any aberrations present in the beam of radiation 36 after leaving the correction device 22 and reports those back to the control unit 30 to instruct the correction device 22.

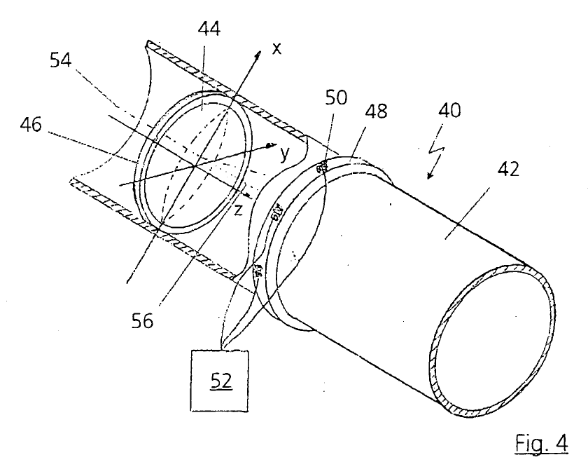

In FIG. 4, an optical device in its entirety is assigned the reference numeral 40.

The optical device 40 comprises a tubular casing 42 within which an optical element in the shape of lens 44 is arranged. The lens 44 is attached to the inside of the casing 42 via an adhesive 46 which is an epoxy-based adhesive that is filled with iron filings as previously described. The magnetic permeability or the dielectric constant of the adhesive 46 is at least 50% higher with the particles susceptible to the magnetic or electric field if an electric field is used instead of a magnetic field than without the particles. Most preferably, the magnetic permeability or dielectric constant of said adhesive is 2, 10 or even 100 times higher with the particles than without the particles.

On the outside of the casing 42, there is arranged a collar 48 comprising a plurality of electromagnets 50 which are connected to a control unit 52. The electromagnets 50 and the collar 48 are arranged in such a fashion that they can apply a magnetic field to the adhesive 46 and thereby exert pushing and pulling forces on the lens 44. In a real system the distance between the collar 48 and the lens 44 and the adhesive 46, respectively, will be much shorter than the distance shown, in order to ensure that a strong enough magnetic field will be applied to the adhesive 46. The system is depicted here with a longer distance in order to simplify the drawing.

If a beam of radiation which is indicated here by a dash-dotted line 54 enters the lens 44, it can happen that it deviates from the optical axis which runs along the Z-axis of the lens 44 in an undesired fashion. In the case shown here, the dash-dotted line 54 deviates in the direction of the Y-axis of lens 44.

If this is detected by a sensor which is not depicted here, the control unit 52 can selectively activate one or several of the electromagnets 50 of the collar 48 in order to apply a magnetic field to the adhesive 46. Such a magnetic field will exert a pushing or pulling force on the particles susceptible to a magnetic field in the adhesive 46 which will be transmitted onto the lens 44. This way the lens 44 can, for example, be tilted around its X-axis, and the beam of radiation can be turned back on the desired optical axis which is here depicted by a dotted line 56.

If a tilting movement is desired it is advantageous, that the electromagnets 50 are activated in a fashion that they exert a pushing force on one side of the tilting axis and a pulling force on the other side, in order to cooperate to produce the desired movement.

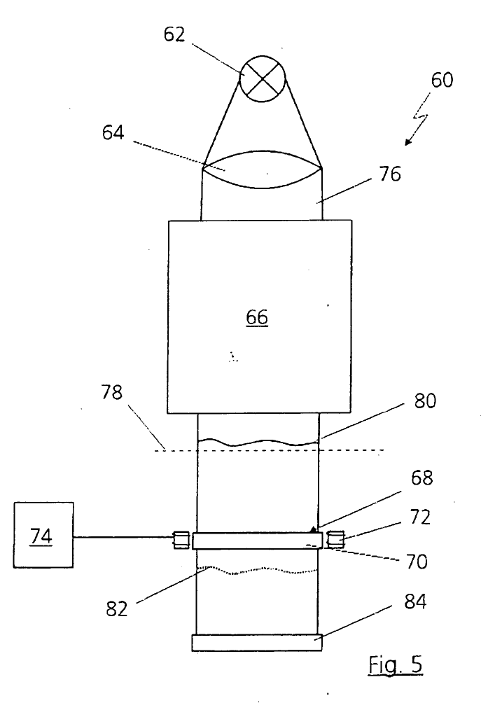

In FIG. 5, an optical device in its entirety is assigned the reference numeral 60.

The optical device 60 comprises a radiation source 62 which emits radiation which is focused by a lens 64 and directed towards an optical system 66. After the optical system 66, a further optical element 68 is arranged which is fixed to a here not depicted casing via an adhesive 70 which is a silicon-based adhesive which has been filled with iron filings. The adhesive 70 is surrounded by a plurality of electromagnets 72 of which only two are depicted here. These electromagnets can be selectively activated by a control unit 74.

When a beam of radiation 76 which is formed by the combination of light source 62 and lens 64 passes through the optical system 66, its wavefront should ideally be planar as indicated by a dash-dotted line 78. Due to aberrations present in the optical system 66, the wavefront is more likely to show certain amounts of peaks and valleys as depicted by the dotted line 80.

These aberrations in the wavefront can be detected, for example, by an interferometer. The information obtained by the interferometer about aberrations in the wavefront can then be used by the control unit 74 to selectively activate one or several of the electromagnets 72 in order to apply a magnetic field to the adhesive 70. This leads to changes in the adhesive 70, such as, for example, an accumulation of material in areas where an attractive force is generated. Such an accumulation of material can exert pressure on the optical element 68. This pressure in turn leads to tensions within the optical element 68 up to minute warpings of the optical element 68. These tensions and warpings can be used to generate wavefront aberrations in a directed fashion so that they show phases directly inverse to those present in the wavefront depicted by the dotted line 80. Wavefront aberrations which have inverse phases will cancel each other out and, therefore, the wavefront after passing the optical element 68 will be close to the desired planar form as depicted by the dotted line 82.

By using this method, a substrate 84 will be irradiated by the beam of radiation 76 which shows an almost completely planar wavefront. Therefore the pattern from a reticle can be projected onto the substrate 84 with only minimal deviations.

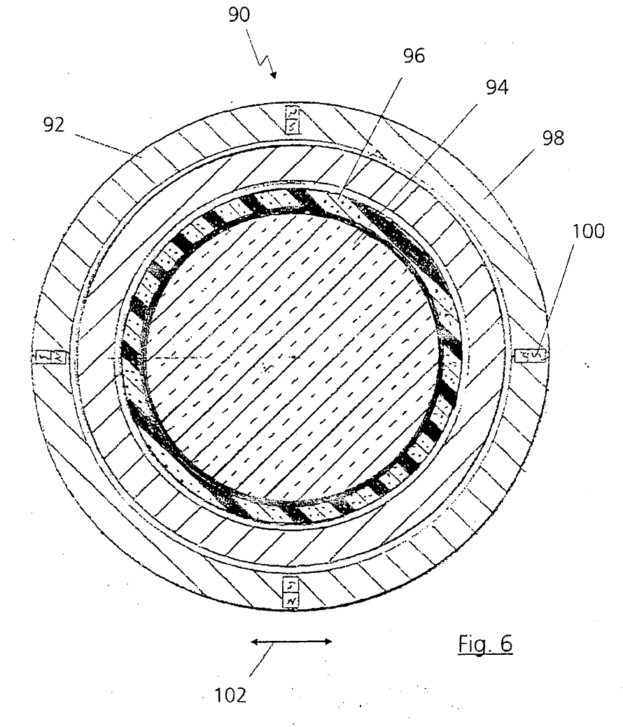

FIGS. 6 to 8 show different embodiments of devices for correcting optical aberrations by applying a magnetic field to an adhesive comprising particles susceptible to a magnetic field. In all those drawings, the devices are arranged in such a way that a device for applying a magnetic field is arranged in the plane of the optical element and the adhesive comprising the particles susceptible to a magnetic field. This is done for simplicity sake, since it gives the reader a better impression of how the various elements cooperate. It is, nevertheless, possible to arrange the devices for applying a magnetic field outside of the plane of the optical element and the adhesive.

In FIG. 6, an optical device in its entirety is assigned the reference numeral 90.

The optical device 90 is a lens system of a lithographic projection device comprising a tubular casing 92 made from aluminum. It is preferable to make the casing from a material which is non-magnetic or only weakly magnetic in order to avoid changes in the magnetic field caused by the casing. Arranged inside the tubular casing 92 is an optical element which in this case is a base plate 94. This base plate 94 is fixed to the inside of the tubular casing 92 by means of a polyurethane based adhesive 96 which is filled with iron filings.

The base plate 94 is a circular plate made from optical grade glass with a diameter of 70 mm and a thickness of 3 mm. The annular gap between the casing 92 and the base plate 94 which is filled by the adhesive 96 is 0.3-0.5 mm wide.

The base plate of a lithographic projection unit has been traditionally used as the main tool in the correction of optical aberrations within such lithographic projection systems. This is mainly due to the fact that being arranged at the very end of the lithographic projection system, this element was the easiest to reach. Due to the fact that with a device as depicted here, all the manipulation can be done from the outside, it is now also possible to use any optical element or even every single optical element present within the optical device.

Arranged around the tubular casing 92 is a collar 98 comprising a plurality of permanent magnets 100 of which four are depicted here. The number of four permanent magnets is not meant to limit the scope of the invention. It is perfectly possible to use more or fewer permanent magnets, it is even possible to use just a single permanent magnet.

The permanent magnets 100 which are depicted here are arranged in a symmetrical fashion and in such a way that they apply pulling forces in two diametrically opposed directions, for example in the picture here, upwards and downwards, and pushing forces in two diametrically opposed directions at a 90° angle from the pulling forces, for example in this case from the left and the right side. This is done in order to apply forces to the adhesive 96 and, therefore, to the base plate 94 which lead to a deformation with to an elliptic shape. This will lead to wavefront aberrations having an elliptic shape.

The collar 98 is arranged around the casing 92 in a rotatable fashion in the directions indicated by a double-headed arrow 102. Therefore, the alignment of the main axis of the elliptic aberration applied to the beam of radiation passing through the optical element 94 can be changed.

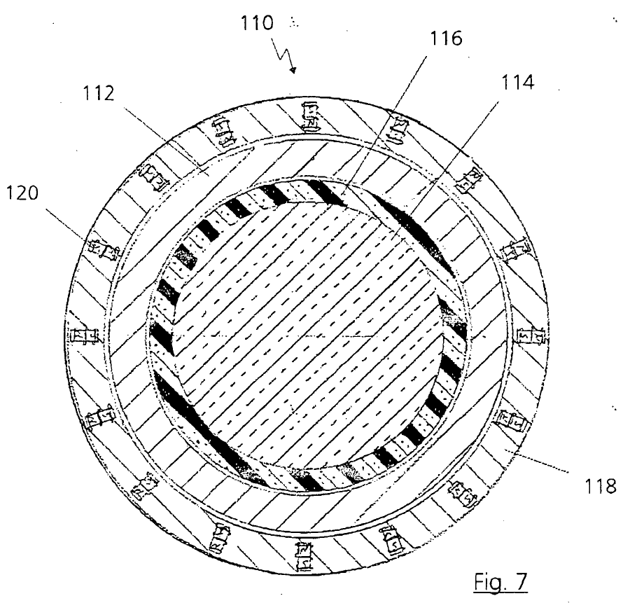

In FIG. 7, an optical device in its entirety is assigned the reference numeral 110.

The optical device 110 comprises a tubular casing 112 inside of which an optical element in the shape of a lens 114 is arranged. The lens 114 is attached to the inside of the tubular casing 112 by an adhesive 116 which in this case is a silicon rubber which is filled with iron filings.

On the outside of the tubular casing, there is arranged a collar 118 comprising a number of electromagnets 120. In this case, sixteen individual electromagnets 120 are depicted but more or fewer electromagnets can be used.

Those electromagnets 120 are individually activatable by a control unit which is not depicted here. By means of this control unit, the polarization as well as the strength of the magnetic field applied by every single electromagnet can be controlled. This way, selective pushing and pulling forces can be applied to the adhesive 116 which will lead to corresponding tensions within the lens 114 or even deformations of the lens 114. This again-can be used to induce wavefront aberrations with a phase inverse to wavefront aberrations present in a beam of radiation passing through lens 114.

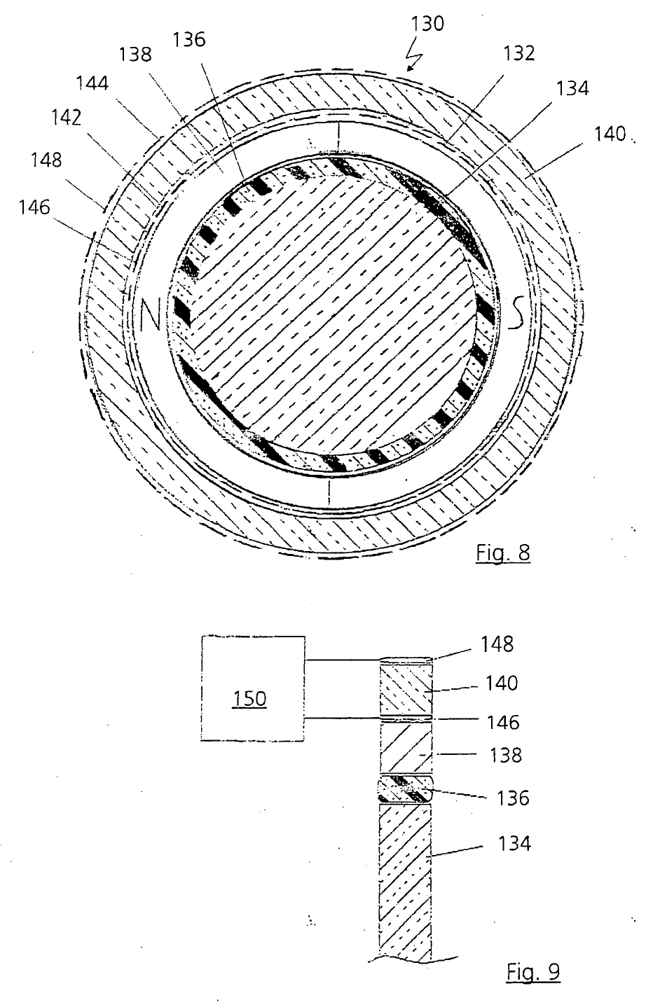

In FIG. 8, an optical device in its entirety is assigned the reference numeral 130.

The optical device 130 comprises a tubular casing 132 inside which a base plate 134 is arranged.

The base plate 134 is attached to the inside of the tubular casing 132 via an adhesive 136 which in this case is a polythiol-based adhesive which has been filled with iron filings.

The section of the tubular casing 132 which is shown in this drawing is a ring shaped permanent magnet 138. In its basic state, the ring shaped permanent magnet 138 exerts a constant magnetic field onto the adhesive 136.

Arranged around the ring shaped permanent magnet 138 is a piezoelectrically active ceramic collar 140 made from a lead circonate titanate-based material. Arranged between the collar 140 and the ring shaped permanent magnet 138 is a first electrode 142 and on the outside of the collar 140 a second electrode 144 is arranged.

These electrodes 142 and 144 comprise individual electrode segments which are designated 146 on the inside of the collar and 148 on the outside of the collar 140.

The electrodes 142 and 144 or, more precisely, the segments 146 and 148 can be used to selectively apply a current to the collar 140. Since the collar 140 is made from a piezoelectrically active material, this will generate a piezoelectric effect within the material which leads to changes in the shape of the collar 140.

Since the collar 140 is fitted flush around the electromagnet 138, these changes will be directly transmitted onto the electromagnet 138. Any of those transmitted changes will lead to local changes in the magnetic field. These changes in the local magnetic field will lead to local changes within the adhesive 136. The changes in the adhesive 136 are in turn transmitted onto the base plate 134 and can be used to induce wavefront aberrations to cancel out wavefront aberrations present in a beam of radiation passing through the base plate 134.

FIG. 9 shows a side-on view of the section of the optical device shown in FIG. 8.

This drawing shows the sandwich structure present in the optical device 130 of FIG. 8. The base plate 134 is covered by the adhesive 136 which is surrounded by the magnet 138. On top of the magnet 138 the electrode segment 146 is arranged which is connected to the piezoelectrically active collar 140. This collar is then covered by another electrode segment 148.

It also becomes clear in this depiction that the electrode segments 146 and 148 are connected to a control unit 150 which can selectively activate one or more of the electrode segments in order to induce a locally limited piezoelectric effect in the collar 140 which will lead to the changes in the magnetic field and the resulting changes indicated earlier.

It needs to be stressed again that the above-described embodiments are given by means of example only and are not meant to limit the scope of the invention in any way.

What is claimed is:

1. A mount for an optical element having a fitting area for fitting the optical element, wherein located in the fitting area is an additional material whose state can be changed by means of a state changing device in such a way that following change of state of the additional material the optical element is held in the mount in a form-fitting and releasable fashion by the additional material.

2. The mount as claimed in claim 1, wherein the additional material is a magnetorheological liquid.

3. The mount as claimed in claim 2, wherein the state changing device has at least one magnet whose magnetic force can be varied in such a way that the viscosity of the magnetorheological liquid changes.

4. The mount as claimed in claim 3, wherein the magnet has a number of electric coils by means of which the magnetic force can be varied.

5. The mount as claimed in claim 3 or 4, wherein the magnet is of annular design and has circulating pole shoes that are in contact with the magnetorheological liquid.

6. The mount as claimed in claim 3, 4 or 5, wherein an insulator is arranged between the magnet and a part of the mount that can be connected to a housing.

7. The mount as claimed in claim 1, wherein the additional material is a metal.

8. The mount as claimed in claim 7, wherein the state changing device has at least one heat inputting device, where the metal can be brought from a solid into a liquid, or from a liquid into a solid, state by heat input by means of the heat inputting device, and where the metal can be brought from a liquid into a solid state by reducing the heat input or by extracting heat by means of the heat inputting device.

9. The mount as claimed in one of claims 1 to 8, wherein it is of gastight design.

10. The mount as claimed in one of claims 1 to 9, wherein it is installed in a microlithography objective.

11. The mount as claimed in claim 1, wherein the additional material is a electrorheological liquid.

12. The mount as claimed in claim 1, wherein the additional material is of jelly- or rubber-type design.

13. A microlithography objective having a number of optical elements of which at least one is held by means of a mount as claimed in one of claims 1 to 12.

14. A method for fitting an optical element on a mount having a fitting area, the optical element being brought into the fitting area of the mount, wherein the state of an additional material located in the fitting area of the mount or introduced into the fitting area of the mount is changed in such a way that the optical element is held in the mount in a form-fitting fashion with the aid of the additional material and releasably.

15. The method as claimed in claim 14, wherein the viscosity of the additional material is varied.

16. The method as claimed in claim 15, wherein use is made as additional material (7) of a magnetorheological liquid (7a) whose viscosity is varied by means of magnetic force.

17. The method as claimed in claim 14, wherein the aggregate state of the additional material (7) is varied.

18. The method as claimed in claim 17, wherein use is made as additional material (7) of a metal (7b) whose aggregate state is varied by means of varying the input or dissipation of heat.

19. The method as claimed in claim 17 or 18, wherein use is made of a low-melting metal.

20. The method as claimed in claim 14, wherein the stiffness of the additional material (7) is varied.

21. The method as claimed in claim 14, wherein the shape and/or elasticity of the additional material (7) is varied.

22. A method for manipulating an optical device comprising:
a. providing an optical element attached to an optical device by an adhesive comprising particles susceptible to a magnetic or electric field, the magnetic or electric permeability of said adhesive being at least 50% higher with the particles susceptible to a magnetic or electric field than without the particles, and
b. applying a magnetic or electric field to said adhesive, for manipulating said optical element.

23. The method of claim 22, further comprising:
a. measuring an optical property of said optical device,
b. comparing said optical property of said optical device to a given value,
c. manipulating said magnetic or electric field in order to adjust said optical property to said given value.

24. The method of claim 23, wherein said method is performed iteratively.

25. The method of claim 22, wherein said method is performed using a feedback control.

26. The method of claim 22, wherein said magnetic field is applied temporarily.

27. The method of claim 22, wherein said magnetic field is applied continuously.

28. An optical device comprising at least one optical element, said optical element being attached to an optical device via an adhesive comprising particles susceptible to a magnetic or electric field.

29. The optical device of claim 28, further comprising at least one permanent magnet.

30. The optical device of claim 29, comprising one permanent magnet.

31. The optical device of claim 30, whereby said one permanent magnet is ring-shaped.

32. The optical device of claim 31, further comprising at least one piezoelectric element arranged at said ring-shaped permanent magnet.

33. The optical device of claim 32, further comprising a control unit, whereby said control unit is designed to activate said at least one piezoelectric element.

34. The optical device of claim 28, further comprising at least one electromagnet.

35. The optical device of claim 34, comprising a plurality of electromagnets.

36. The optical device of claim 35, further comprising a control unit, whereby said control unit is designed to selectively activate at least one of said plurality of electromagnets.

37. A use of an adhesive, comprising particles susceptible to a magnetic or electric field for attaching an optical element to an optical device.

38. The use of claim 37, wherein said particles susceptible to a magnetic or electric field are selected from the group consisting of ferromagnetic particles, metallic permanent magnetic particles, ceramic ferrimagnetic particles, intermetallic particles of the SECo₅ group, whereby SE is Sm, Y, La or Pr and magneto-strictive particles.

39. The use of claim 37, wherein said adhesive is selected from the group consisting of polyurethane-based adhesives, epoxy resin-based adhesives, epoxy-polythiol-based adhesives, polysulfide-based adhesives and mixtures thereof.

40. The use of claim 37, wherein said optical element is manipulated by applying a magnetic field to said adhesive.

41. The use of anyone of claims 37 through 40, wherein said optical device is a projection device for use in microlithography.
